(19) United States
(12) Patent Application Publication
(10) Pub. No.: US 2025/0307413 A1
(43) Pub. Date: Oct. 2, 2025

(54) METHOD AND DEVICE FOR QUICK BOOT OF HIGH BANDWIDTH MEMORY (HBM) DIES

(71) Applicant: Samsung Electronics Co., Ltd., Gyeonggi-do (KR)

(72) Inventors: Li YANG, Austin, TX (US); Chih-Wei YAO, Saratoga, CA (US); Nhon QUACH, San Jose, CA (US); Kevin YEE, San Jose, CA (US)

(21) Appl. No.: 19/093,822

(22) Filed: Mar. 28, 2025

Related U.S. Application Data
(60) Provisional application No. 63/571,151, filed on Mar. 28, 2024.

(51) Int. Cl. G06F 21/57

(52) U.S. Cl. CPC G06F 21/575

(57) ABSTRACT

Methods and devices are provided in which a central processing unit (CPU) of a first chiplet of a superchip may load a first boot code of the first chiplet and a second boot code of a second chiplet of the superchip. The CPU may initialize the first chiplet based on the first boot code. The CPU may initialize the second chiplet based on the second boot code via first configuration instructions sent through a compute die of the superchip.

### CROSS-REFERENCE TO RELATED APPLICATION

This application claims the priority benefit under 35 U.S.C. § 119(e) of U.S. Provisional Application No. 63/571,151, filed on Mar. 28, 2024, the disclosure of which is incorporated by reference in its entirety as if fully set forth herein.

### TECHNICAL FIELD

The disclosure generally relates to computing architectures. More particularly, the subject matter disclosed herein relates to initialization of high bandwidth memory (HBM) dies.

### SUMMARY

HBM has become a critical component in modern computing architectures, particularly in artificial intelligence (AI) hardware accelerators. HBM is preferred due its high dynamic random access memory (DRAM) bandwidth, which enables rapid data access and processing. To further enhance memory bandwidth, multiple HBM chiplets may be integrated within a single package.

A central processing unit (CPU) in the central compute die may control a boot process by sequentially initializing each HBM chiplet. This method involves loading boot code from an external device and sending boot instructions to each HBM chiplet in sequence.

One issue with the above approach is that the CPU may become a bottleneck, as it must individually manage the boot sequence for each HBM chiplet. This sequential initialization leads to extended boot times and increases the complexity of verifying the security of every HBM chiplet. The reliance on the CPU to both configure and secure each HBM chiplet not only delays the overall boot process but also places undue load on the compute die, potentially affecting system performance.

To overcome these issues, systems and methods are described herein for using a main and follower structure for quick boot of HBM chiplets. One of the HBM chiplets may be designated as the main chiplet, while remaining HBM chiplets may serve as follower chiplets. The main chiplet may first configure itself and then may proceed to boot the follower chiplets. The main chiplet may act as a security master by verifying that each chiplet's hardware signature is valid before allowing the system to boot.

The above approaches significantly reduce the boot time by offloading the boot and security initialization from the CPU to a dedicated main chiplet. This lowers the processing burden on the compute die and enhances overall system security by centralizing and hardening the verification process. Accordingly, this architecture offers a more efficient, faster, and secure method for booting systems with multiple HBM chiplets.

In an embodiment, a method is provided in which a CPU of a first chiplet of a superchip may load a first boot code of the first chiplet and a second boot code of a second chiplet of the superchip. The CPU may initialize the first chiplet based on the first boot code. The CPU may initialize the second chiplet based on the second boot code via first configuration instructions sent through a compute die of the superchip.

In an embodiment, a superchip is provided that includes a compute chip, a first chiplet, and a second chiplet. The first chiplet includes a CPU configured to load a first boot code of the first chiplet and a second boot code of the second chiplet, initialize the first chiplet based on the first boot code, and initialize the second chiplet based on the second boot code via first configuration instructions sent through the compute die.

In an embodiment, a first chiplet of a superchip is provided that includes a processor and a non-transitory computer readable storage medium storing instructions. When executed, the instructions cause the processor to load a first boot code of the first chiplet and a second boot code of a second chiplet of the superchip, initialize the first chiplet based on the first boot code, and initialize the second chiplet based on the second boot code via first configuration instructions sent through a compute die of the superchip.

### BRIEF DESCRIPTION OF THE DRAWING

In the following section, the aspects of the subject matter disclosed herein will be described with reference to exemplary embodiments illustrated in the figures, in which:

FIG. 1 is a diagram illustrating an electronic device, according to an embodiment;

FIG. 2 is a diagram illustrating a superchip architecture, according to an embodiment;

FIG. 3 is a diagram illustrating a boot structure for HBM chiplets, according to an embodiment;

FIG. 4 is a diagram illustrating a main and follower boot structure for HBM chiplets, according to an embodiment;

FIG. 5 is a flowchart illustrating a method for initializing HBM chiplets of a superchip, according to an embodiment; and

FIG. 6 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/of” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

An electronic device, according to one embodiment, may be one of various types of electronic devices utilizing storage devices (e.g., memory devices). The electronic device may use any suitable storage standard, such as, for example, peripheral component interconnect express (PCIe), nonvolatile memory express (NVMe), NVMe-over-fabric (NVMeoF), advanced extensible interface (AXI), ultra path interconnect (UPI), ethernet, transmission control protocol/Internet protocol (TCP/IP), remote direct memory access (RDMA), RDMA over converged ethernet (ROCE), fibre channel (FC), infiniband (IB), serial advanced technology attachment (SATA), small computer systems interface (SCSI), serial attached SCSI (SAS), Internet wide-area RDMA protocol (iWARP), and/or the like, or any combination thereof. In some embodiments, an interconnect interface may be implemented with one or more memory semantic and/or memory coherent interfaces and/or protocols including one or more compute express link (CXL) protocols such as CXL.mem, CXL.io, and/or CXL.cache, Gen-Z, coherent accelerator processor interface (CAPI), cache coherent interconnect for accelerators (CCIX), and/or the like, or any combination thereof. Any of the memory devices may be implemented with one or more of any type of memory device interface including double data rate (DDR), DDR2, DDR3, DDR4, DDR5, low-power DDR (LPDDRX), open memory interface (OMI), Nvlink high bandwidth memory (HBM), HBM2, HBM3, and/or the like. The electronic devices may include, for example, a portable communication device (e.g., a smart phone), a computer, a portable multimedia device, a portable medical device, a camera, a wearable device, or a home appliance. However, an electronic device is not limited to those described above.

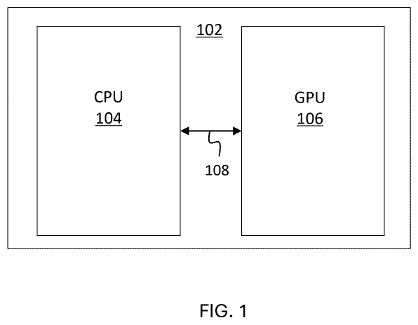

FIG. 1 is a diagram illustrating an electronic device, according to an embodiment. An electronic device (or a user equipment (UE)) 102 may include multiple processing components that require efficient memory for management. The electronic device 102 may include a CPU 104 and an accelerator, such as a graphics processing unit (GPU) 106, interconnected by a memory bus 108. These processing units rely on memory subsystems that must balance high-speed data access with low power consumption.

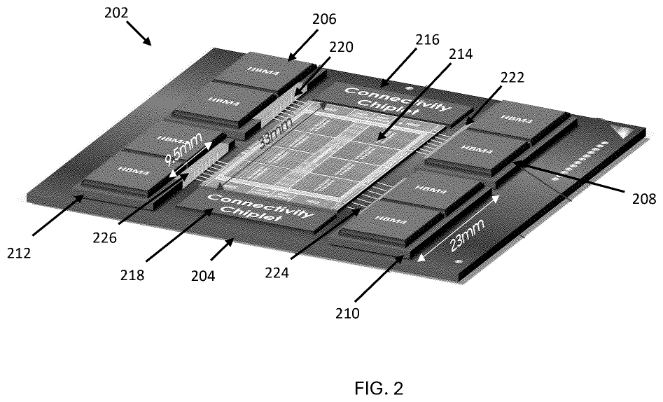

FIG. 2 is a diagram illustrating a superchip architecture, according to an embodiment. A superchip 202 of FIG. 2 may be utilized within an AI accelerator or the GPU 106 of the electronic device 102 of FIG. 1. The superchip 202 may include multiple dies disposed on an interposer 204 (e.g., silicon interposer) or a substrate. The multiple dies of the superchip 202 may include a first HBM chiplet 206, a second HBM chiplet 208, a third HBM chiplet 210, and a fourth HBM chiplet 212, each disposed on the interposer 204 of the substrate. Each of the first through fourth HBM chiplets 206, 208, 210, and 212 may include an HBM4 DRAM and an associated base die. While the superchip 202 of FIG. 2 is shown with a specific number of dies and in a specific configuration, embodiments are not limited to this number of dies or the configuration of dies depicted.

The superchip 202 may also include a compute chiplet 214 (e.g., AI accelerator die) disposed on the interposer 204 or the substrate. The compute chiplet 214 may have dedicated first and second connectivity chiplets 216 and 218 disposed on opposing sides of the compute chiplet 214. The compute chiplet 214 may be connected to the HBM chiplets 206, 208, 210, and 212 via die-to-die (D2D) interconnects (e.g., universal chiplet interconnect express (UCIe) interconnects). Specifically, a first D2D interconnect 220 may connect the first HBM chiplet 206 to the compute chiplet 214. A second D2D interconnect 222 may connect the second HBM chiplet 208 to the compute chiplet 214. A third D2D interconnect 224 may connect the third HBM chiplet 210 to the compute chiplet 214. A fourth D2D interconnect 226 may connect the fourth HBM chiplet 212 to the compute chiplet 214. While the D2D interconnects are disposed at certain locations of the chiplets in FIG. 2, embodiments are not limited to these specific locations.

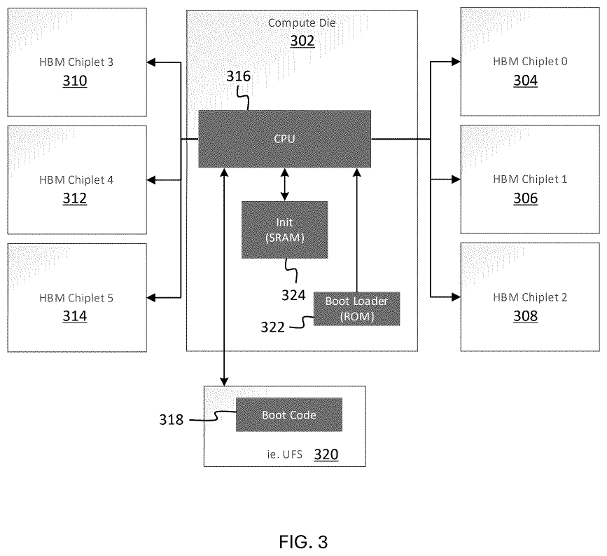

FIG. 3 is a diagram illustrating a boot structure for HBM chiplets, according to an embodiment. The structure of FIG. 3 includes a compute die 302 and multiple HMB chiplets. The compute die 302 may correspond to the compute chiplet 214 (AI accelerator die) described with respect to FIG. 2. The multiple HBM chiplets of FIG. 3 may correspond to the chiplets 206, 208, 210, and 212 described with respect to FIG. 2. Specifically, the multiple HBM chiplets of FIG. 3 may include a first HBM chiplet 304, a second HBM chiplet 306, a third HBM chiplet 308, a fourth HBM chiplet 310, a fifth HBM chiplet 312, and a sixth HBM chiplet 314.

The compute die 302 may include a CPU 316 that controls the boot sequence of the HBM chiplets (304-314). The CPU 316 may load a boot code 318 from an external device (e.g., universal flash storage (UFS)) 320 via a boot loader module (e.g., read only memory (ROM)) 322 and send instructions to the HBM chiplets (304-314) to boot them up one-by-one in sequence. The compute die 302 may also include an initialization module (static random access memory (SRAM)) 324.

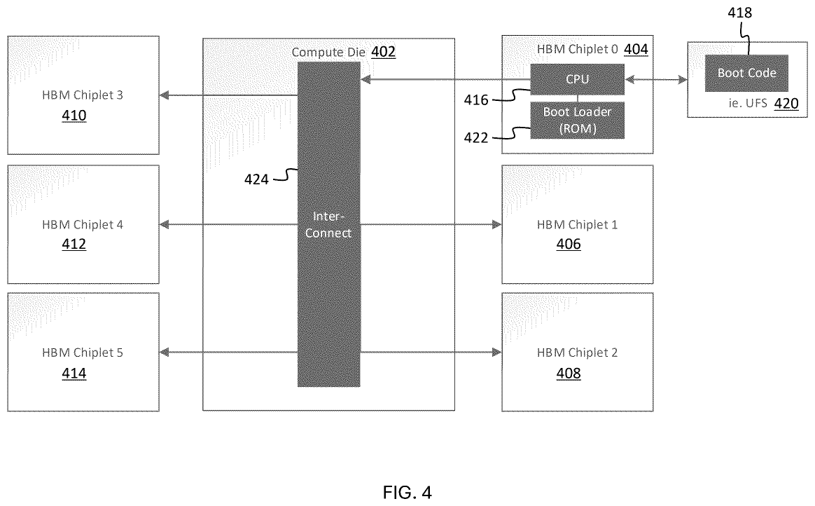

FIG. 4 is a diagram illustrating a main and follower boot structure for HBM chiplets, according to an embodiment. The structure of FIG. 4 includes a compute die 402 and multiple HMB chiplets. The compute die 402 may correspond to the compute chiplet 214 (AI accelerator die) described with respect to FIG. 2. The multiple HBM chiplets of FIG. 4 may correspond to the chiplets 206, 208, 210, and 212 described with respect to FIG. 2. Specifically, the multiple HBM chiplets of FIG. 4 may include a first HBM chiplet 404, a second HBM chiplet 406, a third HBM chiplet 408, a fourth HBM chiplet 410, a fifth HBM chiplet 412, and a sixth HBM chiplet 414.

Instead of booting the HBM chiplets from a CPU of the compute die, as described above with respect to FIG. 3, one of the HBM chiplets may be configured as a main chiplet that boots itself and all other HBM chiplets. For example, as shown in FIG. 4, the first HBM chiplet 404 may be configured as a main chiplet through embedded fuse programming. An embedded fuse is a non-volatile memory cell that may be programmed to store configuration data or other information. The first HBM chiplet 404 may also be configured as the main chiplet by hardwiring through an external general purpose input/output (GPIO) pin or a hardware register. While FIG. 3 illustrates the configuration of a single main HBM chiplet, embodiments are not limited in this manner, and the structure may include the configuration of multiple main chiplets, especially with respect to larger systems.

The first HBM chiplet 404 may include a small CPU 416 that may load boot codes 418 of all HBM chiplets from an external device (e.g., UFS) 420 via a boot loader module (e.g., ROM) 422 of the first HBM chiplet 404.

The CPU 416 may perform a security check to ensure that all hardware signatures are acceptable for all loaded boot codes. Specifically, this security check may be performed before allowing the system to boot. The security of the first HBM chiplet 404 may be guaranteed through a hardware mean, while the security of the remaining HBM chiplets (e.g., follower chiplets 406-414) may be protected by the first HBM chiplet 404. This configuration may reduce the attack surface, and thereby may also reduce the security risk and hardware cost of the system.

The first HBM chiplet 404 may configure (or initialize) itself including all of its internal components (e.g., interconnects, interfaces, and memory ranges). The first HBM chiplet 404 may then send configuration (or initialization) instructions to the remaining HBM chiplets (e.g., follower chiplets 406-414) through an interconnect module 424 of the compute die 402, which can route requests and/or data across different HBM chiplets of the structure. For example, the first HBM chiplet 404 may send first configuration (or initialization) instructions to the second HBM chiplet 406 through the interconnect module 424 of the compute die 402. The first HBM chiplet 404 may send second configuration (or initialization) instructions to the third HBM chiplet 408 through the interconnection module 424 of the compute die 402. The first HBM chiplet 404 may send third configuration (or initialization) instructions to the fourth HBM chiplet 410 through the interconnection module 424 of the compute die 402. The first HBM chiplet 404 may send fourth configuration (or initialization) instructions to the fifth HBM chiplet 412 through the interconnection module 424 of the compute die 402. The first HBM chiplet 404 may send fifth configuration (or initialization) instructions to the sixth HBM chiplet 414 through the interconnection module 424 of the compute die 402.

The HBM configurations (or initialization) may be performed in hardware, in parallel with or before the operating system boot, improving boot latency of the system. CPU load in the compute die 402 may be reduced, improving boot speed and security.

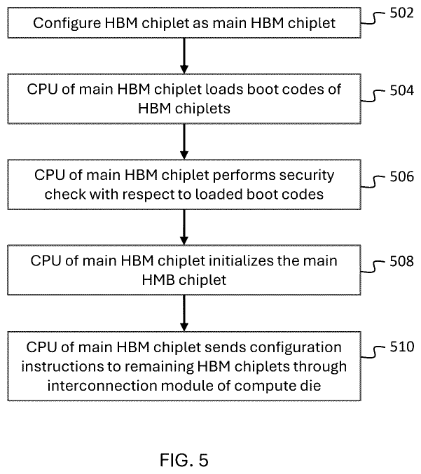

FIG. 5 is a flowchart illustrating a method for initializing HBM chiplets of a superchip, according to an embodiment. At 502, a first HBM chiplet of a superchip may be configured as a main chiplet through embedded fuse programming or hardwiring.

At 504, a CPU of the first HBM chiplet may load boot codes of HBM chiplets of the superchip. The boot codes may be loaded from an external device via a boot loader module of the first HBM chiplet.

At 506, the CPU of the first HBM chiplet may perform a security check to ensure that hardware signatures are acceptable for the first boot code and the second boot code.

At 508, the CPU of the first HBM chiplet may initialize the first chiplet based on a boot code from the loaded boot codes corresponding to the first HBM chiplet. Initializing the first HBM chiplet may include configuring internal components of the first HBM chiplet.

At 510, the CPU of the first HBM chiplet may initialize remaining HBM chiplets of the superchip based on corresponding boot codes by sending respective configuration instructions to each HBM chiplet. The configuration instructions may be sent from the first HBM chiplet to the remaining HBM chiplets through an interconnection module of a compute die of the superchip. The remaining HBM chiplets may be initialized in parallel.

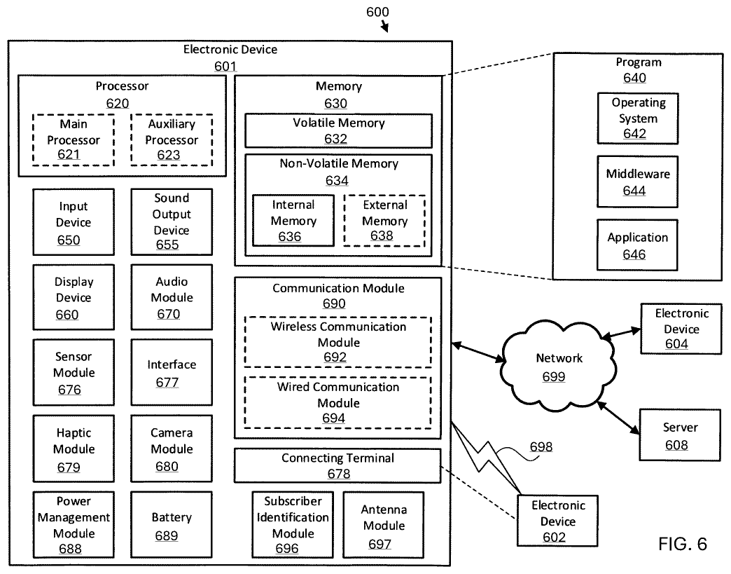

FIG. 6 is a block diagram of an electronic device in a network environment 600, according to an embodiment.

Referring to FIG. 6, an electronic device (or UE) 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display). The processor 620 may utilize the superchip, chiplet, and base die described above with respect to FIGS. 2-5.

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a CPU or an application processor (AP)), and an auxiliary processor 623 (e.g., a GPU, an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623. The auxiliary processor 623 may utilize the superchip, chiplet, and base die described above with respect to FIGS. 2-5.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
loading, by a central processing unit (CPU) of a first chiplet of a superchip, a first boot code of the first chiplet and a second boot code of a second chiplet of the superchip;
initializing, by the CPU, the first chiplet based on the first boot code; and
initializing, by the CPU, the second chiplet based on the second boot code via first configuration instructions sent through a compute die of the superchip.

2. The method of claim 1, further comprising:
configuring the first chiplet as a main chiplet of the superchip through embedded fuse programming or hardwiring.

3. The method of claim 1, wherein the first boot code and the second boot code are loaded from an external device via a boot loader module of the first chiplet.

4. The method of claim 1, further comprising:
performing, by the CPU, a security check to ensure that hardware signatures are acceptable for the first boot code and the second boot code.

5. The method of claim 1, wherein initializing the first chiplet comprises configuring internal components of the first chiplet.

6. The method of claim 1, wherein initializing the second chiplet comprises:
sending, by the CPU, the first configuration instructions to the second chiplet via an interconnection module of the compute die.

7. The method of claim 1, further comprising:
loading, by the CPU, a third boot code of a third chiplet of the superchip; and
initializing, by the CPU, the third chiplet based on the third boot code via second configuration instructions sent through the compute die,
wherein the initializing of the second chiplet and the third chiplet are performed in parallel.

8. A superchip comprising:
a compute chip;
a first chiplet; and
a second chiplet,
wherein the first chiplet comprises a central processing unit (CPU) configured to:
load a first boot code of the first chiplet and a second boot code of the second chiplet;
initialize the first chiplet based on the first boot code; and
initialize the second chiplet based on the second boot code via first configuration instructions sent through the compute die.

9. The superchip of claim 8, wherein the CPU is further configured to:
configure the first chiplet as a main chiplet of the superchip through embedded fuse programming or hardwiring.

10. The superchip of claim 8, wherein the first chiplet further comprises a boot loader module configured to load the first boot code and the second boot code from an external device.

11. The superchip of claim 8, wherein the CPU is further configured to:
perform a security check to ensure that hardware signatures are acceptable for the first boot code and the second boot code.

12. The superchip of claim 8, wherein initializing the first chiplet comprises configuring internal components of the first chiplet.

13. The superchip of claim 8, wherein the compute die comprises an interconnection module, and, in initializing the second chiplet, the CPU is further configured to:
send the first configuration instructions to the second chiplet via the interconnection module of the compute die.

14. The superchip of claim 1, further comprising a third chiplet, wherein the CPU is further configured to:
load a third boot code of the third chiplet; and
initialize the third chiplet based on the third boot code via second configuration instructions sent through the compute die,
wherein the initializing of the second chiplet and the third chiplet are performed in parallel.

15. A first chiplet of a superchip comprising:
a processor; and
a non-transitory computer readable storage medium storing instructions that, when executed, cause the processor to:
load a first boot code of the first chiplet and a second boot code of a second chiplet of the superchip;
initialize the first chiplet based on the first boot code; and
initialize the second chiplet based on the second boot code via first configuration instructions sent through a compute die of the superchip.

16. The first chiplet of claim 15, wherein the instructions further cause the processor to:
configure the first chiplet as a main chiplet of the superchip through embedded fuse programming or hardwiring.

17. The first chiplet of claim 15, wherein the first boot code and the second boot code are loaded from an external device via a boot loader module of the first chiplet.

18. The first chiplet of claim 15, wherein the instructions further cause the processor to:
perform a security check to ensure that hardware signatures are acceptable for the first boot code and the second boot code.

19. The first chiplet of claim 15, wherein, in initializing the second chiplet, the instructions further cause the processor to:
send the first configuration instructions to the second chiplet via an interconnection module of the compute die.

20. The first chiplet of claim 15, wherein the instructions further cause the processor to:
load a third boot code of a third chiplet of the superchip; and
initialize the third chiplet based on the third boot code via second configuration instructions sent through the compute die,
wherein the initializing of the second chiplet and the third chiplet are performed in parallel.
